(19) United States
(12) Patent Application Publication
(10) Pub. No.: US 2021/0398208 A1
(43) Pub. Date: Dec. 23, 2021

(54) METHOD AND DEVICE FOR ISSUING A CREDIT VIA A PAYMENT CHANNEL

(71) Applicant: Robert Bosch GmbH, Stuttgart (DE)

(72) Inventors: Alexander Poddey, Wiernsheim (DE); Fredrik Kamphuis, Kalkar (DE)

(21) Appl. No.: 17/233,228

(22) Filed: Apr. 16, 2021

(30) Foreign Application Priority Data
Jun. 18, 2020 (DE) 102020207563.8

(51) Int. Cl. G06Q 40/02; G06Q 20/10; G06Q 20/40

(52) U.S. Cl. CPC G06Q 40/025; G06Q 20/405; G06Q 20/102

(57) ABSTRACT

A method for granting a credit from an issuer of the credit to a recipient of the credit via a payment channel. The method includes: the issuer and the recipient reach an agreement regarding a payment covering the credit from a payment service provider of the recipient to a payment service provider of the issuer; at least the amount of the credit is frozen on the payment channel for the issuer for an agreed-upon time allowed for payment, the payment service providers are registered; provided a confirmation of the payment takes place by at least one of the payment service providers within the time allowed for payment, the amount is automatically credited by the payment channel to the recipient or the time allowed for payment is extended; otherwise, the amount is automatically released by the payment channel for the issuer after the time allowed for payment elapses.

### CROSS REFERENCE

The present application claims the benefit under 35 U.S.C. § 119 of German Patent Application No. DE 102020207563.8 filed on Jun. 18, 2020, which is expressly incorporated herein by reference in its entirety.

### FIELD

The present invention relates to a method for issuing a credit via a payment channel connecting the issuer to the recipient. The present invention also relates to a corresponding device, a corresponding computer program, and a corresponding memory medium.

### BACKGROUND INFORMATION

Any protocol in computer networks which reaches a consensus regarding the sequence of certain transactions is referred to as a decentralized transaction system, transaction database, or distributed ledger. A frequent characteristic of a system of this type makes use of a blockchain.

The consensus method utilized most frequently according to the related art provides a proof of work (PoW) for the generation of new valid blocks. In order to counter an excessive energy consumption due to the furnishing of such proofs and to thwart an unnecessary growth of the blockchain, so-called transaction or state channels were provided and generalized. An overview of this technology is offered by COLEMAN, Jeff; HORNE, Liam; XUANJI, Li. “Counterfactual: Generalized state channels.” 2018. German Patent Application No. DE 102018210224 A1 describes the following method for reaching an agreement on a cooperation between two systems: The first system dispatches its acceptances regarding the second system and its guarantees granted thereto; conversely, the second system dispatches its acceptances regarding the first system and guarantees granted thereto. A transaction database receives these reciprocal acceptances and guarantees and checks whether they correspond to one another, creates a digital security contract, if necessary, to be concluded between the systems, and, finally, documents this, in that it adds an appropriate block to a blockchain. Thereupon, it dispatches the block including the security contract to both systems, which initiate the cooperation as soon as they receive the block. For this purpose, they establish a reciprocal transaction channel, on which they exchange information and signed messages after receipt of the block. If one of the systems receives a piece of information violating the security contract, it calls upon the transaction database for arbitration. The transaction database informs the other system accordingly, requests therefrom the piece of information which allegedly violates the security contract, and checks it on the basis of the contract.

Such smart contracts embody the legal logic of every distributed application (dApp) of a transaction database. German Patent Application No. DE 102017214902 A1, for example, describes a smart contract for the preparation and/or execution of transactions between a holder of a terminal and a service provider, the smart contract containing conditions of the service provider for services of an information service provider, in particular conditions regarding user charges, preferably a toll, and/or for services of a service provider, in particular conditions regarding license fees preferably regarding parking fees, fuel charges, charging station fees for the terminal, and/or conditions regarding insurance, and/or conditions regarding user fees, preferably regarding fees for sharing the terminal for providing and/or canceling a service, and/or conditions defined by the holder for this terminal for accepting and/or terminating the service, the smart contract being executed in an authorization node of a blockchain-based computer network.

As PCT Patent Application No. WO2019180589A1 verifies by way of example on the basis of a so-called hashlock method, payment channels implemented in a suitable way or generalized state channels may also be utilized in cases, in which the trustworthiness of the infrastructure and the payment partners has not been demonstrated. Corresponding implementations are referred to in the following as trustless channels.

### SUMMARY

The present invention provides a method for granting a credit via a payment channel connecting the issuer with the recipient, a corresponding device, a corresponding computer program, and a corresponding machine-readable memory medium.

An example embodiment of the present invention is based on the finding that trustless channels according to the related art require the active participation of all involved parties and, generally, the deposit of an appropriate amount of money, which finally guarantees the security. This may not be absolutely desirable to the participants of interaction networks; for example, users are reluctant to buy and hold volatile cryptocurrencies, in order to be able to utilize them to finance such trustless channel set-ups.

On the other hand, a plurality of approaches exists for secure legal transactions beyond the blockchain. The security of these conventional transactions is not ensured on a trust basis or via prefinancing, but rather via regulations, in particular laws, and contracts based thereon.

Here, for example, the regulation of the banking sector plays a role, which is often perceived by the cryptographic community as an inconvenient burden, but which serves the purpose, among other things, of giving the customer confidence. Mention should be made, for example, of deposit protection and the certainty that the bank may not debit an amount from a customer account for no reason. For example, if Alice enters a transfer from her account at bank B_{A} to Bob's account at bank B_{B}, it is ensured that the money, when debited from Alice's account, is credited to Bob's account after a certain time delay. If one of the administrators (in the present example, a bank) disregards these rules, customers, interested parties, or even responsible authorities may fine it and, possibly, even hold it liable for any damage, which the affected customer may incur. Such determining factors are referred to in the following as “justified confidence”.

Apart from the aspect of justified confidence, i.e., a property in favor of the particular user or originator, these systems are frequently approaches for a plurality of socio-economic issues, for example, with regard to anti-money laundering regulations or tax regulations. Although the cryptographic community frequently considers these systems and approaches to be too complex and rigid, their complexity and rigidity are due not least to the compliance with the various regulatory requirements.

On the other hand, with respect to cryptography-supported approaches, such as, for example, in payment transactions, it is not clear so far whether the regulatory requirements are to be applied or whether they are compliable. Recent adaptations of regulations, for example, of the European Anti-Money Laundering Directive, suggest that the same set of rules will necessarily be applied to cryptographic approaches over the mid- to long term (as soon as the business volume sufficiently increases).

One advantage of the approach according to an example embodiment of the present invention is that it combines the strengths of the cryptography-based, trustless security elements with justified confidence and, in this way, combines the advantages of both systems. These advantages include, on the one hand, slight, trustlessly efficient high-frequency micro-state transitions and, on the other hand, the simple, widespread and accepted alignment with a plurality of regulatory requirements.

Advantageous refinements of and improvements on embodiments of the present invention described herein are possible as a result of the measures described herein.

### BRIEF DESCRIPTION OF THE DRAWINGS

Exemplary embodiments of the present invention are represented in the figures and are explained in greater detail in the description below.

FIG. 1 shows the flowchart of a method according to a first specific embodiment of the present invention.

FIG. 2 schematically shows a control unit according to a second specific embodiment of the present invention.

### DETAILED DESCRIPTION OF EXAMPLE EMBODIMENTS

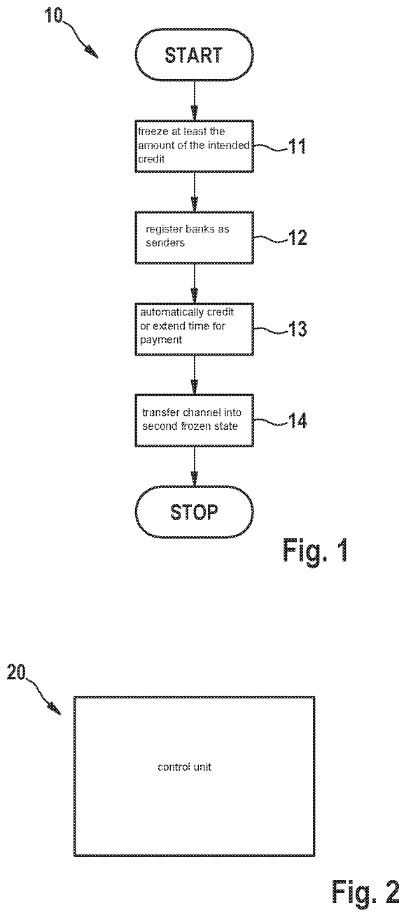

FIG. 1 illustrates the basic steps of a method according to the present invention, which will now be explained with reference to a trustless channel between the participants Alice and Ingrid. Here, the aforementioned channel may form an integral part of a more complex network, in which, for example, Ingrid appears merely as an intermediary.

For the sake of simplicity, at this point, an already established and financed trustless channel is presumed as the starting point, which was set up between Alice and Ingrid, as is common within the scope of conventional protocols. It is to be noted that the following additional steps may also be part of the opening or anchoring of the trustless channel in the chain, and, in fact, in the form of a simple channel design without virtual channels or channel networks up to recursive virtual networks with an arbitrary number of participants. Nevertheless, these steps are to be illustrated on the basis of a conventional channel, in which Alice and Ingrid are able to agree, without chain operations, on new rules, which are documented as smart contracts and reciprocally signed by the participants. In addition, only a single state X and a transfer directed from Alice to Ingrid—in return for a credit from Ingrid to Alice on the channel—is considered, merely by way of example.

Assume that Alice and Ingrid started from state X_{A}=20, X_{I}=10 of the channel and, due to an arbitrary transaction, reached inversely state X_{A}=10, X_{I}=20, X_{A} and X_{I} representing the balances of Alice and Ingrid, respectively, on the channel.

Usually, the channel would be closed afterwards at a certain point in time, so that Ingrid could freely access and spend the difference of 10. This closure is possibly not desirable, however, since it is associated with additional effort—for example, for transactions in the blockchain—or is considered to be an asset transfer, which is subjected to taxes or regulations, for example, to avoid money laundering. It is also conceivable that a value is not ascribed to the state per se, but rather this value is regulated only by a (civil law) contract between Alice and Ingrid; the trustless channel is utilized in this case only for the fiduciary, forgery-proof accounting between Alice and Ingrid.

In order to circumvent these problems, an approach based on justified confidence is followed, in which Alice may transfer the equivalent of the amount 10 outside the channel. This option is utilized in order to balance the trustless channel again, instead of simply closing it. However, it is to be ensured that none of the participants suffers a loss in value.

The aforementioned approach is explained in the following by way of example with reference to a banking network. Nevertheless, it is to be noted that, instead of a bank, another payment service provider may also enjoy the justified confidence of at least one of the parties. The term “payment service provider” is to be interpreted in a broad sense here; trustworthy services without governmental approval may also fall thereunder.

Assume that this method based on justified confidence (referred to in the following as an external transfer) is a bank transfer. Alice is a customer of bank B_{A}, while Ingrid's bank is designated as B_{I}. Moreover, it is assumed that Alice would like to transfer the equivalent of the amount 10 on the channel to Ingrid's credit, in order to restore the channel to its starting state X_{A}=20, X_{I}=10.

The steps described in the following are to be implemented within the existing channel framework. The specific implementation depends on the configuration of the channel. The present description is to be appropriately adapted to the particular utilized framework.

Initially, Alice informs Ingrid that she would like to carry out this settlement with the aid of an external transfer. The relevant message contains the channel-specific information and, possibly, information regarding the execution and conditions of the external transfer, its value, etc. Alice signs this proposal in the usual way. The message signed by Alice is designated as m_{A}_{₁}.

Provided Ingrid agrees, she sends Alice a verifiable accept signal (typically a countersigned copy). As a function of the underlying channel protocol, Ingrid's response may contain, for example, the message signed by Alice or a copy of the proposal signed by Ingrid. Regardless of the content, this message, which signals the agreement reached between the two parties, is uniformly designated as m_{A}_{₁}_{I}_{₁} in the following.

According to this agreement, at least the amount 10 of the intended credit is frozen (process 11) on the payment channel for Ingrid for an agreed-upon time allowed for payment. This amount may be increased by a collateral security c, which is automatically released for Ingrid by the payment channel together with the basic amount as soon as the time allowed for payment has elapsed, if the transfer does not go through. The technical implementation of this freeze 11 is reserved for the specific channel implementation; it is also to be noted that an appropriate collateral security is also deposited by Alice to Ingrid's credit.

Next, bank B_{A} and bank B_{I} are registered (process 12) with the payment channel as senders of certificates or certified messages. A registration of this type may take place at the level of the higher-order blockchain, any derived (possibly, virtual) channel, or the dApp specifically anchored in the channel between Alice and Ingrid.

The amount 10 is now frozen in such a way that, under certain circumstances, such as in exchange for proof or confirmation of the transfer by at least one of the banks, it is automatically credited to Alice by the payment channel or, at least, the time allowed for payment is extended (process 13).

Next, Alice may trigger the external transfer to Ingrid. Depending on the amount of confidence that Alice and Ingrid have in bank B_{A} and bank B_{I}, various options are possible for carrying out this transfer.

One conceivable scenario is based on the assumption that Alice and Ingrid would have sufficient confidence in the entire banking system, including the bank of the particular other party. After Alice provides her bank B_{A} with proof of her agreement reached with Ingrid, with the aid of message m_{A}_{₁}_{I}_{₁}, bank B_{A} checks to determine that it was registered with the payment channel within the framework of process 12. Otherwise, bank B_{A} may ignore message m_{A}_{₁}_{I}_{₁} or even sanction Alice's behavior and Ingrid may recover the amount 10, which was frozen in process 11, after the time allowed for payment elapses.

If bank B_{A} finds the agreement to be valid, however, it carries out the transfer to bank B_{I}, which has been guaranteed by the trustworthy banking system, and delivers to Alice and Ingrid a first confirmation of the content that the transfer was initiated. In light of the assumed trustworthiness of the banking system, in the simplest case, this first confirmation may already trigger the credit of the amount 10 to Alice and the release of collateral security c simultaneously “deposited” by Ingrid. (The same applies for any collateral security deposited by Alice to Ingrid's credit.)

In one variant, this confirmation initially transfers the channel into a second frozen state (process 14). The further approach depends on the success of the transfer initiated by bank B_{A}. If the transfer arrives, as expected, within an agreed-upon execution time to Ingrid's credit at bank B_{I}, bank B_{I} delivers a second confirmation to Alice and Ingrid, which finally triggers the credit to Alice and the release of collateral security c for Ingrid. However, if the second confirmation arrives at the payment channel only with delay, Alice is also credited with collateral security c as compensation for the delay.

Under the regulations, bank B_{A} and bank B_{I} form part of a subsystem, that provides for rules and penalties for erroneous transfers. If bank B_{I}, for example, does not credit the amount to Ingrid's account, Ingrid may prove and enforce her claim, in that she presents the first confirmation to a regulating authority, takes bank B_{I} to court, etc. Conversely, if bank B_{A} debits the amount from Alice's account without actually transferring it to bank B_{I}, the same confirmation may be utilized to prove that bank B_{A} has accepted the transfer request, and bank B_{A} could be held liable in accordance with the criteria of justified confidence.

An alternative scenario is based on the assumption that Alice trusts only bank B_{A} and Ingrid trusts only bank B_{I}. In this case, bank B_{A} informs bank B_{I} of the transfer to be carried out, after the proof of the agreement has been presented. (Moreover, the relevant message may be sent to Alice and Ingrid and reset the timer for the transfer of the amount 10 to Ingrid, since Alice has ordered the transfer due to her, as required.) If bank B_{I} agrees, it documents this in the form of message m_{A}_{₁}_{I}_{₁}_{B}_{A}_{₁}B_{I}₁, which, in the simplest case, may once again immediately trigger the credit of the amount 10 to Alice and the release of collateral security c for Ingrid. In one variant, this confirmation—according to the comments presented above—initially transfers the channel into the second frozen state, in which only a second confirmation by bank B_{I} finally triggers the credit to Alice and the release of collateral security c for Ingrid.

This method may be implemented, for example, in software or hardware or in a mixed form made up of software and hardware, for example, in a control unit 20, as the schematic representation from FIG. 2 illustrates.

What is claimed is:

1. A method for granting a credit from an issuer of the credit to a recipient of the credit via a payment channel connecting the issuer with the recipient, the method comprising the following steps:
reaching an agreement, by the issuer and the recipient, regarding a payment covering the credit from a payment service provider of the recipient to a payment service provider of the issuer;
freezing on the payment channel, according to the agreement, at least an amount of the credit for the issuer for an agreed-upon time allowed for payment,
registering on the payment channel the payment service provider of the recipient and the payment service provider of the issuer;
based on a confirmation of the payment taking place, by at least one of the payment service provider of the recipient and the payment serviced provider of the issuer, within the time allowed for payment, the amount is automatically credited by the payment channel to the recipient or the time allowed for payment is extended; and
based on the confirmation not taking place within the time allowed for payment, automatically releasing the amount by the payment channel for the issuer after the time allowed for payment elapses.

2. The method as recited in claim 1, wherein, in addition to a value of the credit, a collateral security is frozen on the payment channel, and when the time allowed for payment elapses and the payment does not occur, the collateral security is automatically released by the payment channel for the issuer.

3. The method as recited in claim 2, wherein:
in response to proof of the agreement, the payment service provider of the recipient checks its registration with the payment channel; and
based on the payment service provider of the recipient finding the agreement to be valid, the payment service provider of the recipient carries out the payment and delivers a first confirmation to the issuer and the recipient.

4. The method as recited in claim 2, wherein:
in response to proof of the agreement, the payment service provider of the recipient informs at least the bank of the issuer about the payment to be carried out; and
based on the payment service provider of the issuer approving the payment, the payment service provider of the issuer delivers a first confirmation.

5. The method as recited in claim 3, wherein the first confirmation triggers the credit and the release of the collateral security.

6. The method as recited in claim 4, wherein the first confirmation triggers the credit and the release of the collateral security.

7. The method as recited in claim 3, wherein:
when the payment service provider of the recipient receives the payment, the payment service provider of the recipient delivers a second confirmation to the issuer and the recipient; and
the second confirmation triggers the credit and the release of the collateral security.

8. The method as recited in claim 4, wherein:
when the payment service provider of the recipient receives the payment, the payment service provider of the recipient delivers a second confirmation to the issuer and the recipient; and
the second confirmation triggers the credit and the release of the collateral security.

9. The method as recited in claim 7, wherein:
when an agreed-upon execution time elapses between the first confirmation and the second confirmation, the collateral security is also credited to the recipient.

10. The method as recited in claim 8, wherein:
when an agreed-upon execution time elapses between the first confirmation and the second confirmation, the collateral security is also credited to the recipient.

11. A non-transitory machine-readable memory medium on which is stored a computer program for granting a credit from an issuer of the credit to a recipient of the credit via a payment channel connecting the issuer with the recipient, wherein an agreement by the issuer and the recipient is reached regarding a payment covering the credit from a payment service provider of the recipient to a payment service provider of the issuer, the computer program, when executed by a computer, causing the computer to perform the following steps:
freezing on the payment channel, according to the agreement, at least an amount of the credit for the issuer for an agreed-upon time allowed for payment,
registering on the payment channel the payment service provider of the recipient and the payment service provider of the issuer;
based on a confirmation of the payment taking place, by at least one of the payment service provider of the recipient and the payment serviced provider of the issuer, within the time allowed for payment, the amount is automatically credited by the payment channel to the recipient or the time allowed for payment is extended; and
based on the confirmation not taking place within the time allowed for payment, automatically releasing the amount by the payment channel for the issuer after the time allowed for payment elapses.

12. A device configured to grant a credit from an issuer of the credit to a recipient of the credit via a payment channel connecting the issuer with the recipient, wherein an agreement by the issuer and the recipient is reached regarding a payment covering the credit from a payment service provider of the recipient to a payment service provider of the issuer, the device configured to:
freezing on the payment channel, according to the agreement, at least an amount of the credit for the issuer for an agreed-upon time allowed for payment,
registering on the payment channel the payment service provider of the recipient and the payment service provider of the issuer;
based on a confirmation of the payment taking place, by at least one of the payment service provider of the recipient and the payment serviced provider of the issuer, within the time allowed for payment, the amount is automatically credited by the payment channel to the recipient or the time allowed for payment is extended; and
based on the confirmation not taking place within the time allowed for payment, automatically releasing the amount by the payment channel for the issuer after the time allowed for payment elapses.
